(19) United States
(12) Patent Application Publication
(10) Pub. No.: US 2021/0090791 A1
(43) Pub. Date: Mar. 25, 2021

(54) Magnetic Inductive Coil Module

(71) Applicants: Chih-Hung Lin, New Taipei City (TW); Kun-Chuan Chang, New Taipei City (TW)

(72) Inventors: Chih-Hung Lin, New Taipei City (TW); Kun-Chuan Chang, New Taipei City (TW)

(73) Assignee: PIN SHINE INDUSTRIAL CO., LTD., New Taipei City (TW)

(21) Appl. No.: 16/583,232

(22) Filed: Sep. 25, 2019

(51) Int. Cl. H01F 27/30; H01F 27/32; H01F 27/28; H01F 27/29

(52) U.S. Cl. CPC H01F 27/306; H01F 27/324; H01F 2027/2809; H01F 27/29; H01F 27/2804

(57) ABSTRACT

A coil module includes a first coil set and a second coil set. The first coil set has an isolation frame. The second coil set has an open first winding body. The first winding body has two ends which are out of contact with each other. One of the two ends has a first conductive portion projecting from the first winding body. The other one of the two ends has a connecting end from which an open second winding body is integratedly outward extended. A terminal of the second winding body has a second conductive portion which is outward protrudent. The connecting end comprises a bent portion which makes the second winding body and the first winding body arranged in the same direction so that the second winding body and the first winding body are attached on two opposite sides of the isolation frame.

### TECHNICAL FIELD

The invention relates to coil modules, particularly to inductive elements such as inductors or transformers.

### RELATED ART

Magnetic inductive elements such as transformers must have two independent coils, i.e., a primary coil and a secondary coil. Voltages across the two coils can be transformed in a turn ratio of the two coils according to the electromagnetic induction principle.

In actual applications, a transformer is usually mounted on an independent insulative base. The insulative base is provided with conductive pins for connecting the coils with an external circuit. Also, the insulative base can serve as signal isolation to prevent interference.

With the trend of compactness of customer electronics, transformers also become thinner and lighter. Known prior art has provided a planar transformer formed by printing two coil-shaped patterns to serve as two coils on a printed circuit board. In manufacture, such a planar transformer still has drawbacks as follows:

1. Printing two coils on a printed circuit board is so complicated and difficult and such a transformer possesses a small withstand current. As a result, costs of such a transformer is too high and is hard to have competitiveness in the market.

2. Insulative paint is painted between the two coils for isolation. It is hard to meet the requirements of safety of transformers so as to make transformers easy to be damaged. Especially for step-down transformers connecting mains electricity, the voltage across their primary coils is high, so isolation between a primary coil and a secondary coil must be good enough.

3. When assembling a magnetic core, a central magnetic column of the magnetic core must pass assembling holes reserved in each coil. Alignment of these assembling holes must be very accurate, otherwise assembling difficulty will rise or the gap between the coil and the magnetic core will be too large. Automatic mass production is hard to be implemented.

Another conventional transformer is to put pre-made planar coils (including primary and secondary coils) around a magnetic core and provide a base with pins. The coils are connected to an external circuit by soldering. The base may serve as isolation between the magnetic core and the external circuit.

Obviously, such a planar metal coils may be formed by molding or stamping. Its manufacturing costs is much less than the coils made on a PCB and is more suitable for mass production. Also, such a transformer can withstand greater current than the printed coils on a PCB. But there are several drawbacks in manufacture as follows:

1. Isolation with safe distance between planar coils lacks. As abovementioned, even if insulative paint is painted between the two coils for isolation, it is still hard to meet the requirements of safety of transformers. Especially for step-down transformers connecting mains electricity, the voltage across their primary coils is high so as to make transformers easy to be damaged.

2. Each coil is an independent element. When they are assembled with a magnetic core, a central magnetic column of the magnetic core must pass assembling holes reserved in each coil. Alignment of these assembling holes must be very accurate. Assembling difficulty will rise to cause time consuming and the yield rate will be low. Automatic mass production is hard to be implemented.

3. The pins are fixed on an independent base first and each terminal of all coils must be separately connected to one of the pins. When more turns of the coils are needed, efficiency of production must be affected. Obviously, the more the number of connections is, the more the number of errors, for example, blind or misconnected. As a result, the yield rate will decrease.

### SUMMARY OF THE INVENTION

An object of the invention is to provide a magnetic inductive coil module, which is easy to be manufactured and assembled and can increase the yield rate.

To accomplish the above object, the magnetic inductive coil module includes a first coil set and a second coil set. The first coil set has an isolation frame. The second coil set has an open first winding body. The first winding body has two ends which are out of contact with each other. One of the two ends has a first conductive portion projecting from the first winding body. The other one of the two ends has a connecting end from which an open second winding body is integratedly outward extended. A terminal of the second winding body has a second conductive portion which is outward protrudent. The connecting end comprises a bent portion which makes the second winding body and the first winding body arranged in the same direction so that the second winding body and the first winding body are attached on two opposite sides of the isolation frame.

The second coil set is made by molding or stamping. This can decrease manufacturing costs and is easy to implement. The second coil set is formed by integratedly connecting the first winding body and the second winding body. This simplifies the assembling process. Especially for the connection with an external circuit, what is needed is to connect the first conductive portion to the second conductive portion. This reduces possibility of blind joint and increases reliability.

The isolation frame is sandwiched by the second coil set. This is advantageous to the coating of the isolation layer. The isolation frame is provided with a positioning trough corresponding to both the first winding body and the second winding body in contour for alignment and assembling. This enhances a positioning effect.

Furthermore, the invention has another embodiment. The second coil set has multiple continuous open first winding bodies. The first winding bodies have a first conductive portion projecting from the first winding body and connecting ends from which continuous open second winding bodies are integratedly outward extended. A terminal of the second winding bodies has a second conductive portion which is outward protrudent. Preferably, the first winding bodies are the same as the second winding bodies in shape. Each of the connecting ends includes a bent portion which makes the second winding bodies and the first winding bodies arranged in the same direction. This can increase the turns of the second coil set.

### BRIEF DESCRIPTION OF THE DRAWINGS

FIG. 1 is an exploded view of the invention;

FIG. 2 is a schematic view of the second coil set which is unfolded of the invention;

FIG. 3 is a perspective view of the invention;

FIG. 4 is another perspective view of the invention;

FIG. 5 is a cross-section view of the invention along line 5-5 in FIG. 3;

FIG. 6 is a perspective view of another embodiment of the invention; and

FIG. 7 is a schematic view of the second coil set which is unfolded of still another embodiment of the invention.

### DETAILED DESCRIPTION OF THE INVENTION

The invention provides a magnetic inductive coil module which can serve as an inductor or a transformer.

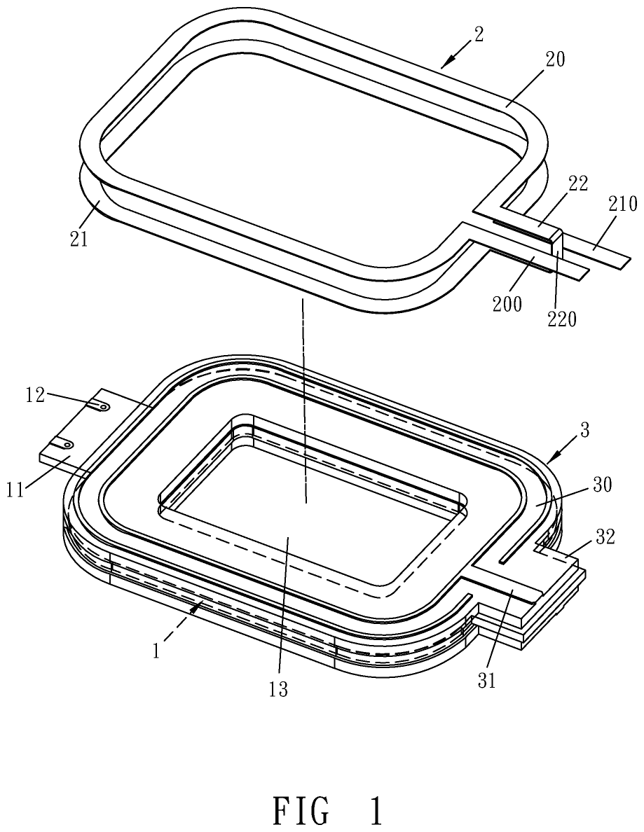

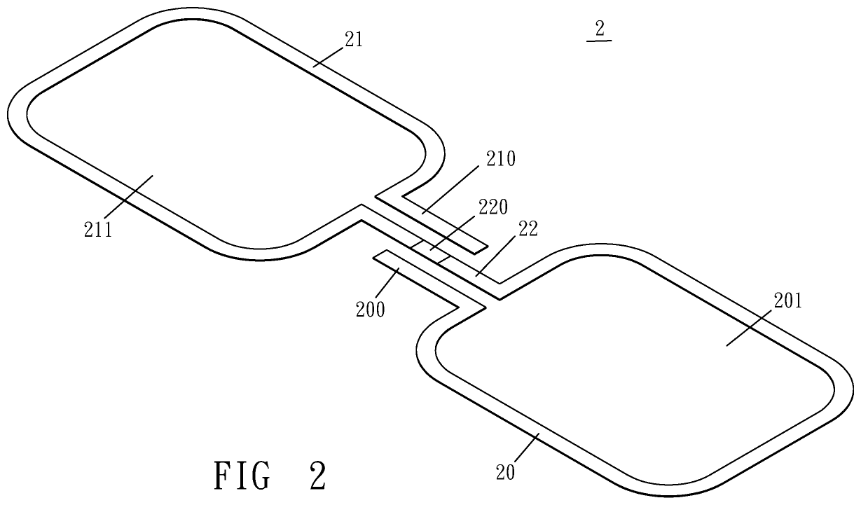

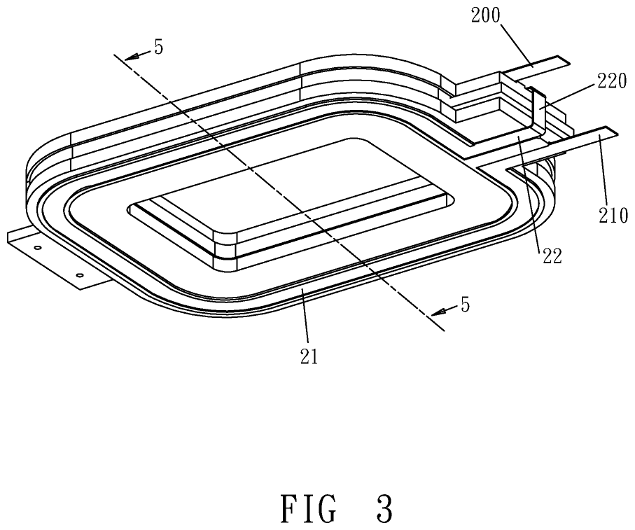

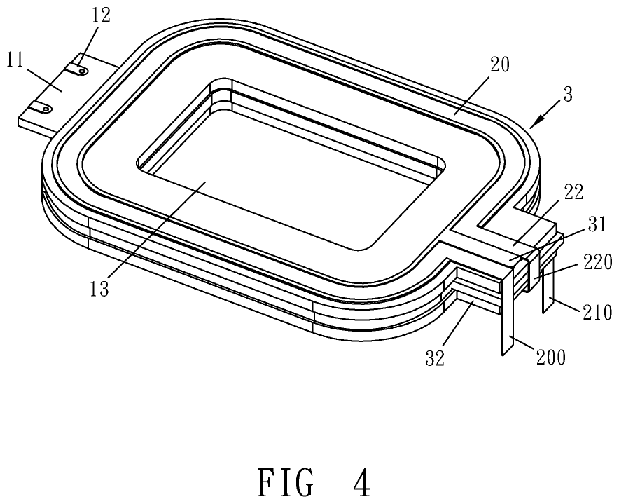

Please refer to FIGS. 1-5. The invention includes a first coil set 1 and a second coil set 2. The outside of the first coil set 1 has an isolation frame 3. The second coil set 2 is attached on two opposite sides of the isolation frame 3 to form a coil module as shown in FIGS. 3 and 4.

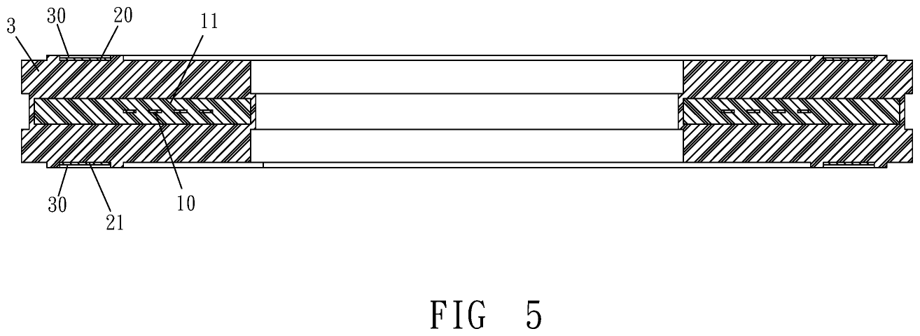

Please refer to FIGS. 1 and 5. The first coil set 1 is a conductive pattern 10 disposed on an insulative substrate 11. For example, the conductive pattern 10 is printed on a printed circuit board (PCB) to form the first coil set 1. Another available way is to lay the conductive pattern 10 on the insulative substrate 11. In addition, a side of the insulative substrate 11 may be provided with contacts 12 connected with the conductive pattern 10 for connecting an external circuit. An inner hole 13 is formed in the first coil set 1 for receiving a magnetic core of a transformer.

The second coil set 2 is a flat coil made of a conductive material by molding, stamping or other methods and has an open first winding body 20. The first winding body 20 has two ends which are out of contact with each other. One of the two ends has a first conductive portion 200 projecting from the first winding body 20. The other one of the two ends is a connecting end 22 from which an open second winding body 21 is integratedly outward extended. A terminal of the second winding body 21 has a second conductive portion 210 which is outward protrudent. Preferably, the first winding body 20 is the same as the second winding body 21 in shape. The connecting end 22 includes a bent portion 220 which makes the second winding body 21 and the first winding body 20 arranged in the same direction.

The isolation frame 3 provides insulation and isolation to the first coil set 1 by covering the first coil set 1 with exposing the contacts 12. Such covering may be implemented by injection molding of insulative material outside the first coil set 1 or putting the first coil set 1 around a premade isolation frame. Preferably, the isolation frame 3 is provided with a positioning trough 30 around the inner hole 13 and corresponding to both the first winding body 20 and the second winding body 21 in contour for alignment and assembling. Also, a protrusion 31 is formed between the connecting end 22 and the first conductive portion 200 and between the connecting end 22 and the second conductive portion 210 for isolation. The isolation frame 3 is provided a carrier 32 in contraposition with the contact 12 for being mounted by the first conductive portion 200 and the second conductive portion 210.

When assembling, put the first winding body 20 beside the first coil set 1 covered by the isolation frame 3 first. Then, bend the bent portion 220 to make the second winding body 21 oriented toward and be parallel with the first winding body 20 and to make the first coil set 1 sandwiched between the first winding body 20 and the second winding body 21 as shown in FIGS. 3 and 4. Meanwhile, winding holes 201, 211 of the first winding body 20 and the second winding body 21 correspond to the inner hole 13 of the first coil set 1 for receiving a magnetic core. Preferably, both the first winding body 20 and the second winding body 21 are embedded into the positioning trough 30 to increase a positioning effect. The first conductive portion 200 and the second conductive portion 210 are arrange at two opposite sides of the carrier 32 for being inserted by pins or being soldered by the surface mount technology (SMT). The connecting end 22 and the bent portion 220 are attached on the carrier 32 to enhance the positioning of the second coil set 2. Please refer to FIG. 4. The first conductive portion 200 and the second conductive portion 210 may be perpendicularly bent toward the first winding body 20 in the same direction.

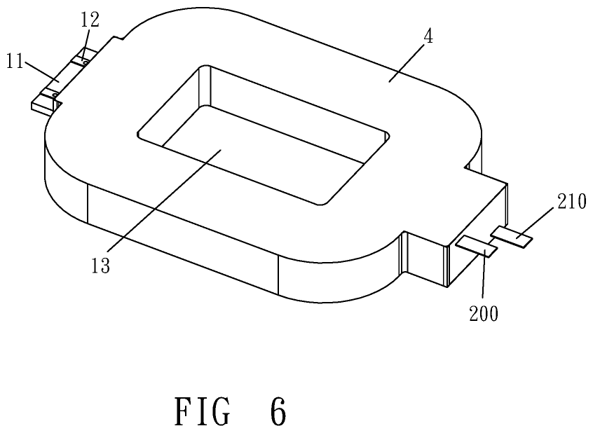

Preferably, as shown in FIG. 6, the coil module can be covered by an isolation layer 4 with exposing the contacts 12, the first conductive portion 200 and the second conductive portion 210.

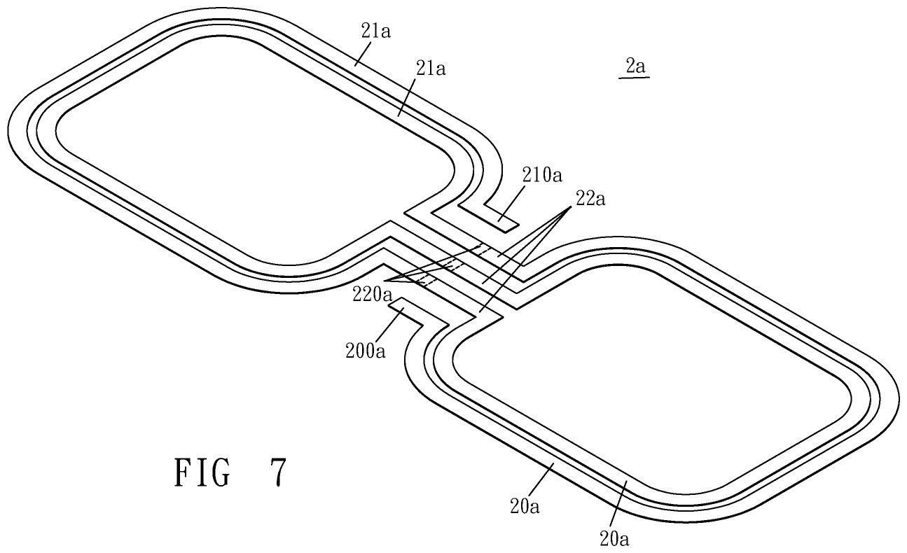

Please refer to FIG. 7, which shows a schematic view of the second coil set of still another embodiment of the invention. The second coil set 2a has multiple continuous open first winding bodies 20a. The first winding bodies 20a have a first conductive portion 200a projecting from the first winding body 20a and connecting ends 22a from which continuous open second winding bodies 21a are integratedly outward extended. A terminal of the second winding bodies 21a has a second conductive portion 210a which is outward protrudent. Preferably, the first winding bodies 20a are the same as the second winding bodies 21a in shape. Each of the connecting ends 22a includes a bent portion 220a which makes the second winding bodies 21a and the first winding bodies 20a arranged in the same direction. This can increase the turns of the second coil set 2a.

In comparison with the prior art, the invention has advantages as follows:

1. The second coil set 2 is made by molding or stamping. This can decrease manufacturing costs and is easy to implement.

2. The second coil set 2 is formed by integratedly connecting the first winding body 20 and the second winding body 21. This simplifies the assembling process. Especially for the connection with an external circuit, what is needed is to connect the first conductive portion 200 to the second conductive portion 210. This reduces possibility of blind joint and increases reliability.

3. The isolation frame 3 is sandwiched by the second coil set 2. This is advantageous to the coating of the isolation layer 4. Particularly, the isolation frame 3 is provided with a positioning trough 30 corresponding to both the first winding body 20 and the second winding body 21 in contour for alignment and assembling. This enhances a positioning effect.

4. When using the invention to serve as a transformer, a magnetic core can be easily inserted the inner hole 13 to accomplish assembling. This simplifies the manufacturing process and increases the yield rate.

It will be appreciated by persons skilled in the art that the above embodiments have been described by way of example only and not in any limitative sense, and that various alterations and modifications are possible without departure from the scope of the invention as defined by the appended claims.

What is claimed is:

1. A magnetic inductive coil module comprising:
a first coil set having an isolation frame; and
a second coil set, having an open first winding body, wherein the first winding body has two ends which are out of contact with each other, one of the two ends has a first conductive portion projecting from the first winding body, another one of the two ends has a connecting end from which an open second winding body is integratedly outward extended, and a terminal of the second winding body has a second conductive portion which is outward protrudent;
wherein the connecting end comprises a bent portion which makes the second winding body and the first winding body arranged in the same direction so that the second winding body and the first winding body are attached on two opposite sides of the isolation frame.

2. The magnetic inductive coil module of claim 1, wherein the isolation frame is made of insulative material covering the first coil set.

3. The magnetic inductive coil module of claim 1, wherein the isolation frame is formed by insulative material in advance to be surrounded by the first coil set.

4. The magnetic inductive coil module of claim 1, wherein an inner hole is formed in the first coil set corresponding to winding holes of the first winding body and the second winding body.

5. The magnetic inductive coil module of claim 1, wherein the isolation frame is provided with a positioning trough corresponding to both the first winding body and the second winding body in contour.

6. The magnetic inductive coil module of claim 1, wherein the first coil set is a conductive pattern disposed on an insulative substrate, a side of the insulative substrate is provided with contacts connected with the conductive pattern, and the contacts are exposed from the isolation frame.

7. The magnetic inductive coil module of claim 1, wherein an end of the isolation frame is provided a carrier, and the first conductive portion and the second conductive portion are separately mounted on two opposite sides of the carrier.

8. The magnetic inductive coil module of claim 1, wherein a protrusion is formed between the connecting end and the first conductive portion and between the connecting end and the second conductive portion.

9. The magnetic inductive coil module of claim 1, wherein the coil module is covered by an isolation layer with exposing the first conductive portion and the second conductive portion.

10. A magnetic inductive coil module comprising:
a first coil set having an isolation frame; and
a second coil set, having continuous open first winding bodies, wherein the first winding bodies have a first conductive portion projecting from the first winding bodies and connecting ends from which continuous open second winding bodies are integratedly outward extended with the same direction, and a terminal of the second winding bodies has a second conductive portion which is outward protrudent;
wherein each of the connecting ends comprises a bent portion which makes the second winding bodies and the first winding bodies arranged in the same direction so that the second winding bodies and the first winding bodies are attached on two opposite sides of the isolation frame.
